(19) United States
(12) Patent Application Publication
(10) Pub. No.: US 2024/0301256 A1
(43) Pub. Date: Sep. 12, 2024

(54) RESIN COMPOSITION, PROTECTIVE SHEET AND DISPLAY DEVICE INCLUDING THE SAME

(71) Applicants: SAMSUNG DISPLAY CO., LTD., YONGIN-SI (KR); SAMHWA PAINTS INDUSTRIES CO., LTD., Ansan-si (KR)

(72) Inventors: SUNG KIM, Anyang-si (KR); BO SUN KIM, Ansan-si (KR); WOOK HYUNG LEE, Gunpo-si (KR); NAMHEE PARK, Hwaseong-si (KR); HYUNG-DON NA, Seoul (KR); SUNGYOUL CHO, Seoul (KR)

(21) Appl. No.: 18/664,970

(22) Filed: May 15, 2024

Related U.S. Application Data
(62) Division of application No. 17/114,885, filed on Dec. 8, 2020.

(30) Foreign Application Priority Data
Feb. 14, 2020 (KR) 10-2020-0018171

(51) Int. Cl. C09J 151/08; B32B 7/12; B32B 27/36; C08F 220/24; C08F 220/28; C08F 283/00; C08L 33/06; C08L 33/16; C09J 7/22

(52) U.S. Cl. CPC C09J 151/08; B32B 7/12; B32B 27/36; C08F 220/24; C08F 220/286; C08F 283/002; C08L 33/062; C08L 33/16; C09J 7/22; B32B 2457/20; C09J 2301/122; C09J 2451/00

(57) ABSTRACT

The present disclosure provides a resin composition, and a protective sheet of a display device that includes the resin composition. The resin composition includes alkyl acrylate, polyethylene glycol alkyl ether methacrylate, hydroxyalkyl acrylate, perfluorinated alkyl (meth)acrylate, and silicone (meth)acrylate.

### CROSS-REFERENCE TO RELATED APPLICATIONS

This U.S. non-provisional patent application claims priority under 35 U.S.C. § 119 of Korean Patent Application No. 10-2020-0018171, filed on Feb. 14, 2020, and under 35 U.S.C. § 120 of U.S. patent application Ser. No. 17/114,885, filed on Dec. 8, 2020 the contents of which are incorporated by reference herein in their entirety.

### BACKGROUND

The present disclosure relates to a resin composition, a protective sheet formed of the resin composition, and a display device including the protective sheet.

Display devices show various images on a display to provide information to users. Typically, display devices show information within an allotted screen. A television, mobile phone, and computer are examples of display devices. Flexible display devices include a flexible display panel to allow the device to be folded or bent.

A protective sheet may be used in a display device to protect display surfaces. The reliability of the display device depends on the protective sheet. However, in some cases moisture may cause damage to the protective sheet. Therefore, there is a need in the art to continue increasing display protection with an adhesive layer with increased wettability and adhesive properties.

### SUMMARY

The present disclosure provides a resin composition with increased wettability and adhesive strength, and a protective sheet including an adhesive layer prepared therefrom. The disclosure also provides a display device with increased reliability in an operating state such as folding by including a protective sheet with increased adhesive strength.

An embodiment of the inventive concept provides a resin composition including alkyl acrylate, polyethylene glycol alkyl ether methacrylate, hydroxyalkyl acrylate, perfluorinated alkyl (meth)acrylate, and silicone (meth)acrylate. The perfluorinated alkyl (meth)acrylate may include an alkyl group of 1 to 6 carbon atoms and 3 to 13 fluorine atoms. The polyethylene glycol alkyl ether methacrylate may include 4 to 20 repeating ethylene glycols.

The silicone (meth)acrylate may be represented by Formula 1 below.

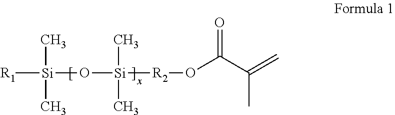

In Formula 1 above, R₁ is an alkyl group with 1 to 20 carbon atoms, R₂ is an alkylene group with 1 to 20 carbon atoms, and X is an integer of 1 to 20.

The resin composition may include 58 to 88 parts by weight of the alkyl acrylate, 8 to 12 parts by weight of the polyethylene glycol alkyl ether methacrylate, 1.5 to 2.5 parts by weight of the hydroxyalkyl acrylate, 8 to 12 parts by weight of the perfluorinated alkyl (meth)acrylate, and 4 to 6 parts by weight of the silicone (meth)acrylate.

The alkyl acrylate may include a linear alkyl acrylate with 1 to 4 carbon atoms and a branched alkyl acrylate with 6 to 10 carbon atoms. The resin composition may include 16 to 24 parts by weight of the linear alkyl acrylate and 42 to 64 parts by weight of the branched alkyl acrylate.

In an embodiment of the inventive concept, a protective sheet includes an adhesive layer formed of an adhesive composition and a base film, wherein the adhesive composition includes a resin composition according to an embodiment, a C9 type hydrocarbon resin, and a curing agent. The curing agent may be a diisocyanate-based compound. The C9 type hydrocarbon resin may be a copolymer of at least one monomer selected from among indene, styrene, methylindene, alphamethylstyrene, or vinyltoluene. The adhesive layer may have a thickness of about 5 μm to about 40 μm.

In an embodiment of the inventive concept, a display device includes a display module and a protective sheet disposed on the display module. The display module may include a display panel and a window disposed on the display panel, wherein the window may include a base substrate and at least one functional layer disposed on the base substrate and including a fluorine-containing compound. The adhesive layer may be directly disposed on a functional layer including the fluorine-containing compound, and a bond may not be formed between the adhesive layer and the functional layer.

The adhesive strength of the protective sheet to the functional layer including the fluorine-containing compound may be about 10 gf/inch to about 100 gf/inch. The display module may be folded with respect to at least one bending axis.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view of a display device according to an embodiment;

FIG. 2 is a view illustrating a display device shown in FIG. 1 in a folded state;

FIG. 3 is an exploded perspective view of a display device according to an embodiment;

FIG. 4 is a cross-sectional view of a display device according to an embodiment; and

FIG. 5 is a cross-sectional view showing an area AA of FIG. 4.

### DETAILED DESCRIPTION

The present disclosure relates generally to a protective sheet formed of the resin composition, and a display device including the protective sheet. In some embodiments, the resin composition increases the wettability and adhesive strength of an adhesive layer of the protective sheet to protect the display device.

Display devices, especially foldable or bendable devices, are prone to damage from moisture if the moisture seeps through the protective layers, rendering the display device useless. As a result, increased wettability and adhesive strength to bind the protective layers may increase the longevity of a mobile phone, television, or computer.

Thus, according to some embodiments of the present disclosure, a protective sheet includes an adhesive layer formed of an adhesive composition and a base film. The adhesive composition includes a resin composition such as a hydrocarbon resin, and a curing agent.

A hydrocarbon resin, or petroleum resin, may refer to an aromatic hydrocarbon used to increase the tackiness (i.e., stickiness) of a surface. Hydrocarbon resins can be by-products of petroleum cracking, and may be produced using a combination of pretreatment, polymerization and distillation. Hydrocarbon resins are a low polymer, and may have a molecular weight between 300-3000. In some cases, hydrocarbon resins are used together with other kinds of resins as promoters, adjusting agents and modifiers in a hot-melt adhesive or a pressure-sensitive adhesive.

The present disclosure provides a resin composition for display panel protection. The resin composition includes alkyl acrylate, polyethylene glycol alkyl ether methacrylate, hydroxyalkyl acrylate, perfluorinated alkyl (meth)acrylate, and silicone (meth)acrylate.

The inventive concept may be modified in many alternate forms. Therefore, specific embodiments will be exemplified in the drawings and described in detail. It should be understood that specific embodiments are not intended to limit the inventive concept to the particular forms disclosed, but rather, are intended to cover all modifications, equivalents, and alternatives falling within the spirit and technical scope of the inventive concept.

In the present disclosure, when an element (or a region, a layer, a portion, etc.) is referred to as being “on,” “connected to,” or “coupled to” another element, the element may be directly disposed on/connected to/coupled to the other element, or that a third element may be disposed therebetween.

Meanwhile, in the present specification, “directly disposed” means that there is no layer, film, region, plate or the like added between a portion of a layer, a film, a region, a plate or the like and other portions. For example, “directly disposed” may mean disposing without additional members such as an adhesive member between two layers or two members

Like reference numerals refer to like elements. Also, in the drawings, the thickness, the ratio, and the dimensions of elements are exaggerated for an effective description of technical contents.

The term “and/or,” includes all combinations of one or more of which associated configurations may define.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concept. The terms of a singular form may include plural forms unless the context clearly indicates otherwise.

Additionally or alternatively, terms such as “below,” “lower,” “above,” “upper,” and the like are used to describe the relationship of the configurations shown in the drawings. The terms are used as a relative concept and are described with reference to the direction indicated in the drawings. Additionally or alternatively, the term “disposed on” in the present disclosure may indicate the case where any one member is disposed on a lower part as well as on an upper part

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as with meanings consistent with the meanings in the context of the related art, and are expressly defined herein unless the terms are interpreted in an idealized or overly formal sense.

It should be understood that the terms “comprise”, or “have” are intended to specify the presence of stated features, integers, steps, operations, elements, components, or combinations thereof in the disclosure, but do not preclude the presence or addition of one or more other features, integers, steps, operations, elements, components, or combinations thereof.

Hereinafter, a resin composition, a protective sheet, and a display device according to an embodiment of the inventive concept will be described with reference to the accompanying drawings.

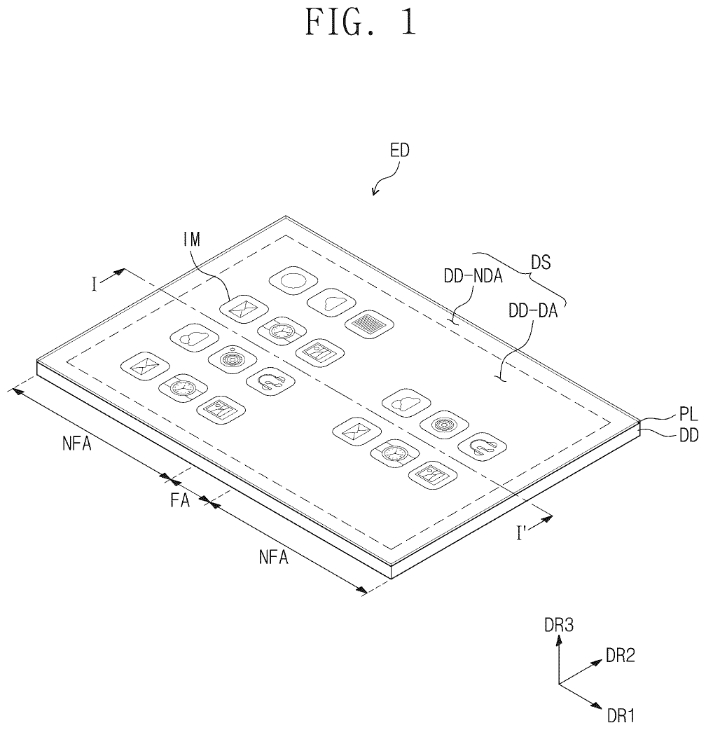

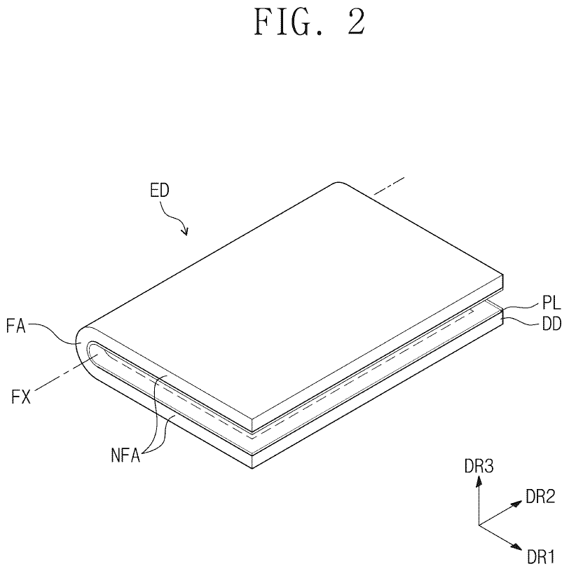

FIG. 1 is a perspective view of a display device ED according to an embodiment. FIG. 2 is a view illustrating the display device shown in FIG. 1 in a folded state.

Referring to FIG. 1, a display device ED of an embodiment may have a rectangular shape which has long sides extending in a first directional axis DR1 direction and short sides extending in a second directional axis DR2 direction which crosses the first directional axis DR1. However, an embodiment of the inventive concept is not limited thereto. The display device ED may have various shapes such as circular and polygonal shapes. The display device ED may be rigid or flexible.

The display device ED, according to an embodiment of the inventive concept, may be for large-sized electronic devices such as a television set and a monitor and small to medium-sized electronic devices such as a mobile phone, a tablet, a car navigation unit, a game console, and a smartwatch. In FIG. 1, a smartphone is exemplarily illustrated as the display device ED.

In the display device ED, according to an embodiment, a display surface DS on which an image IM is displayed may be parallel to a plane defined by the first directional axis DR1 and the second directional axis DR2. The normal direction of the display surface DS and/or the thickness direction of the display device ED is indicated by a third directional axis DR3. A front surface (or an upper surface) and a rear surface (or a lower surface) of each member may be defined by the third directional axis DR3. However, the directions indicated by the first to third directional axes DR1, DR2, and DR3 are relative concepts, and may thus be changed to other directions. Hereinafter, first to third directions correspond to directions indicated by the first to third directional axes DR1, DR2, DR3, respectively, and are given the same reference numerals.

The display device ED, according to an embodiment, may be a flexible display device. In this case, the display device ED may include at least one folding region FA. Referring to FIGS. 1 and 2, the display device ED may include the folding region FA and a plurality of non-folding regions NFA. The folding region FA is disposed between the non-folding regions NFA. The folding region FA and the non-folding regions NFA may be arranged adjacent to each other in the first directional axis DR1 direction.

The folding region FA may be a portion deformable into a shape which is folded along a folding axis FX extending in one direction such as the second directional axis DR2 direction.

FIGS. 1 and 2 exemplarily show one folding region FA and two non-folding regions NFA. However, the numbers of the folding region FA and the non-folding regions NFA are not limited thereto. For example, the display device ED may include a plurality of non-folding regions NFA the number of which is more than two, and a plurality of folding regions FA disposed between the non-folding regions NFA.

In the display device ED of an embodiment, the non-folding regions NFA may be symmetrical to each other with respect to the folding region FA. However, the embodiment of the inventive concept is not limited thereto and the folding region FA is disposed between the non-folding regions NFA, but the areas of two non-folding regions NFA facing each other with respect to the folding region FA may be different.

The display surface DS of the display device ED may include a display region DA and a non-display region NDA around the display region DA. The display region DA may display an image, and the non-display region NDA may not display an image. The non-display region NDA may surround the display region DA, and define the edge of the display device ED.

The display device ED, according to an embodiment, may include a display module DD and a protective sheet PL disposed on the display module DD.

The protective sheet PL is disposed on the display module DD. The protective sheet PL is transparent, and even when the protective sheet PL is attached, image information provided from the display surface DS of the display module DD can be identified.

Since the protective sheet PL includes an adhesive layer AL containing a resin composition according to an embodiment, the protective sheet PL has increased wettability and adhesive strength for the display module DD to protect the surface of the display module DD. The term wettability refers to the ability of the protective sheet PL to maintain contact with display surface DS, based on intermolecular interactions when the two are brought together. In some cases, the degree of wettability is determined by a force balance between adhesive and cohesive forces.

Accordingly, even when the display device ED is folded or bent, a lifting phenomenon at an interface is prevented, and the display device ED may exhibit increased reliability. Additionally or alternatively, adhesion to the surface of the display module DD is not permanently maintained since the protective sheet PL does not form a bond with an adhesive surface of the display module DD. For example, an adhesive layer may be readily detached without being transferred to the surface of the display module DD when the protective sheet PL is intentionally removed by a user.

Referring to FIG. 2, the display device ED may be a foldable display device ED which is folded or unfolded. For example, the folding region FA may be folded along the folding axis FX, where the folding axis FX is parallel to the second directional axis DR2, so that the display device ED may be folded. The folding axis FX may be defined as a minor axis parallel to the short sides of the display device ED.

When the display device ED is folded, the non-folding regions NFA face each other, and the display device ED may be in-folded such that the display surface DS is not exposed to the outside. However, the embodiment of the inventive concept is not limited thereto. Unlike the case illustrated in the drawing, the display device ED may be folded such that the display surface DS is exposed to the outside.

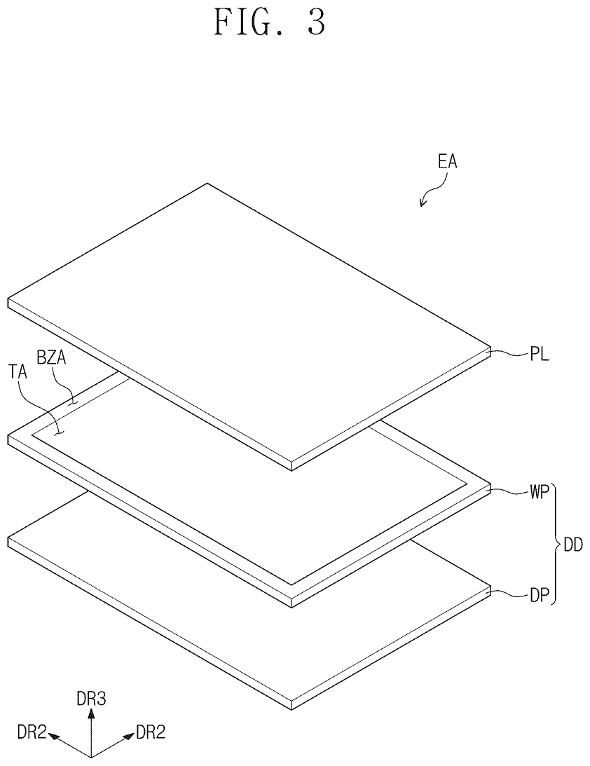

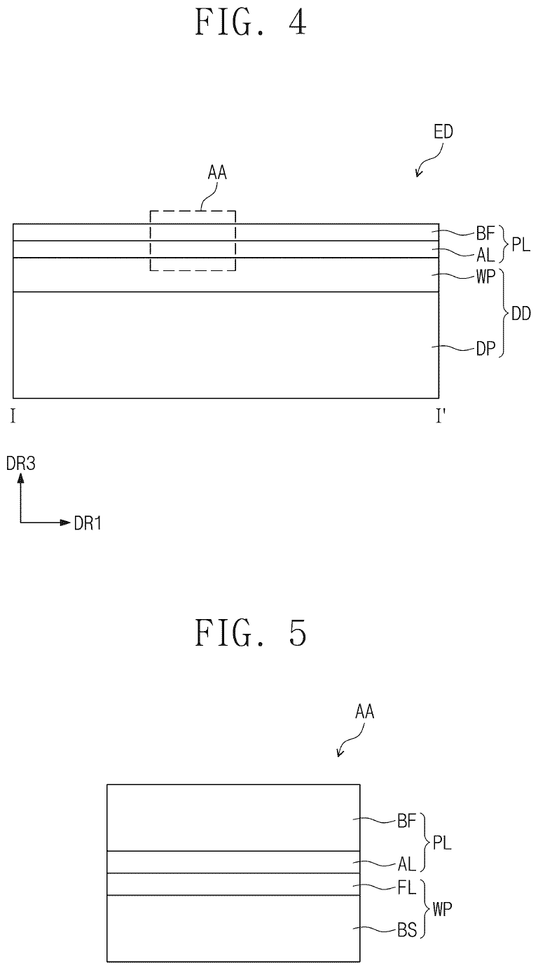

FIG. 3 is an exploded perspective view of a display device ED of an embodiment. FIG. 4 is a cross-sectional view of a display device ED of an embodiment. FIG. 4 may be a cross-sectional view of a portion corresponding to line I-I′ of FIG. 1. FIG. 5 is a view schematically showing an area “AA” of FIG. 4.

The display device ED of an embodiment may include a display module DD and a protective sheet PL disposed on the display module DD. The display module DD may include a display panel DP and a window WP.

The display panel DP may generate an image and provide the generated image in a predetermined direction or directions. The display panel DP may provide the generated image in the third directional axis DR3 (FIG. 2) direction. For example, the display panel DP may be an organic light-emitting display panel. However, the embodiment of the inventive concept is not limited thereto, and the display panel DP may be a liquid crystal display panel, a plasma display panel, an electrophoretic display panel, a microelectromechanical system display panel, or an electrowetting display panel.

The display panel DP may be a rigid display panel or a flexible display panel. The display panel DP may include a flexible substrate.

An image IM generated from the display panel DP may be provided to a user by being transmitted through the window WP. In the display device ED including the folding region FA, the window WP may be a flexible window, but is not limited thereto.

The window WP may include a transmission area TA and a bezel area BZA. A front surface of the window WP including the transmission area TA and the bezel area BZA corresponds to a front surface of the display device ED.

The transmission area TA may be an optically transparent area. The bezel area BZA may be an area with a relatively lower light transmittance than the transmission area TA. The bezel area BZA may have a predetermined color. The bezel area BZA may be adjacent to the transmission area TA and surround the transmission area TA. The bezel area BZA may define the shape of the transmission area TA. However, the embodiment of the inventive concept is not limited to the illustration, and the bezel area BZA may be disposed adjacent to one side of the transmission area TA and a part thereof may be omitted.

Meanwhile, referring to FIG. 5, the window WP may include a base substrate BS and at least one functional layer FL disposed on the base substrate BS.

The base substrate BS may include a glass substrate or a polymer resin substrate. For example, the base substrate BS used in the window WP may include a tempered glass substrate. Additionally or alternatively, the base substrate BS may be a polymer resin substrate. For example, the base substrate BS may be formed by including a polyimide resin, etc. The base substrate BS included in the window WP may have high transmittance. The window WP may exhibit high transmittance to allow images provided from the display panel DP to be transmitted and protect the display panel DP from external shock.

The functional layer FL may include at least one of a hard coating layer, a fingerprint prevention layer, or a scattering prevention layer. In an embodiment, the functional layer FL may include a fluorine-containing compound. In an embodiment, the functional layer FL, including a fluorine-containing compound, may be a fingerprint prevention layer.

A protective sheet PL of an embodiment includes an adhesive layer AL and a base film BF disposed on the adhesive layer AL. In the protective sheet PL according to an embodiment, the base film BF may include at least one polymer resin among polyethylene terephthalate (PET), poly(butylene terephthalate) (PBT), polyethylene naphthalene (PEN), polycarbonate (PC), poly(methylmethacrylate) (PMMA), polystyrene (PS), polyvinylchloride (PVC), polyethersulfone (PES), polypropylene (PP), polyamide (PA), polyphenylene ether (m-PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR), and thermoplastic polyurethane (TPU).

The adhesive layer AL, according to an embodiment, may be disposed on the window WP, and for example, the adhesive layer AL may be directly disposed on the functional layer FL of the window WP. The adhesive layer AL does not form a separate bond with an adhesive surface of the window WP. For example, the adhesive layer AL does not form a separate bond with the functional layer FL when the adhesive surface is the functional layer FL.

In an embodiment, when the functional layer FL includes a fluorine-containing compound, the protective sheet PL including the adhesive layer AL may have an adhesive strength of about 10 gf/inch to about 100 gf/inch with respect to the functional layer FL at room temperature as an adherend surface. The protective sheet PL may have an adhesive strength of about 10 gf/inch to about 30 gf/inch. Meanwhile, in the present description, the room temperature may refer to a temperature of about 25° C.

The adhesive layer AL may have a thickness of about 5 μm to about 40 μm. When the thickness of the adhesive layer AL is less than 5 μm, the adhesive strength of the protective sheet PL to a display module DD may be reduced. Additionally or alternatively, when the thickness of the adhesive layer AL is greater than 40 μm, the total thickness of a display device ED may become thicker.

The adhesive layer AL of an embodiment includes a resin composition according to an embodiment, and an adhesive composition containing a hydrocarbon resin and a curing agent. Additionally or alternatively, the adhesive layer AL may be a layer formed by curing the adhesive composition.

Types of hydrocarbon resins include C5 Resins, C9 Resins, C5/C9 copolymer resins, and hydrogenated resins. C5 Resins may be produced from aliphatic crackers like Piperylene and Isoprene, an a catalyst such as AlCl3. C9 Resins may be produced from aromatic crackers like Vinyltoluenes, Indene, Alpha Methylstyrene, Stryene, Methylindenes, and a catalyst such as BF3. C5/C9 copolymer resins are produced from both aliphatic crackers and aromatic crackers. In some cases, hydrogenation may be used to neutralize a double bond of the hydrocarbon resin.

In an embodiment, the adhesive composition may include 80 to 120 parts by weight of the resin composition, 4 to 10 parts by weight of a C9 type hydrocarbon resin, and 0.1 to 0.2 parts by weight of the curing agent. When the adhesive composition includes each component in the above range, ensuring the transparency of the adhesive layer AL including the adhesive composition may be possible, and increased adhesive strength and reliability may be achieved.

The resin composition, according to an embodiment, includes alkyl acrylate, polyethylene glycol alkyl ether methacrylate, hydroxyalkyl acrylate, perfluorinatedalkyl (meth)acrylate, and silicone (meth)acrylate. Meanwhile, in the present description, (meth)acrylate refers to acrylate or methacrylate.

The type of the alkyl acrylate included in the resin composition of an embodiment is not particularly limited, but may be a linear alkyl acrylate with 1 to 4 carbon atoms and/or a branched alkyl acrylate with 6 to 10 carbon atoms. For example, the resin composition of an embodiment may include a linear alkyl acrylate with 1 to 4 carbon atoms and a branched alkyl acrylate with 6 to 10 carbon atoms.

Examples of the linear alkyl acrylate with 1 to 4 carbon atoms include methyl acrylate, ethyl acrylate, propyl acrylate, butyl acrylate, etc., but are not limited thereto. Examples of the branched alkyl acrylate with 6 to 10 carbon atoms include 2-ethylhexyl acrylate, 2-ethylpentyl acrylate, 2-ethylheptyl acrylate, 2-ethylnonyl acrylate, 2-propylhexyl acrylate, 2-propyloctyl acrylate, etc., but are not limited thereto.

In an embodiment, the resin composition may include 58 to 88 parts by weight of the alkyl acrylate. Additionally or alternatively, the resin composition may include 16 to 24 parts by weight of a linear alkyl acrylate, and 42 to 64 parts by weight of a branched alkyl acrylate.

The type of polyethylene glycol (PEG) alkyl ether methacrylate included in the resin composition of an embodiment is not particularly limited, but may include 4 to 20 repeating ethylene glycols, or 5 to 16 ethylene glycols, or 6 to 12 ethylene glycols. Examples of the polyethylene glycol alkyl ether methacrylate include PEG methyl ter methacrylate, PEG ethyl ter methacrylate, PEG propyl ether methacrylate, PEG butyl ether methacrylate, etc., but are not limited thereto.

Examples of the hydroxyalkyl acrylate included in the resin composition of an embodiment include hydroxyethyl acrylate, hydroxypropyl acrylate, hydroxybutyl acrylate, etc., but are not limited thereto.

The perfluorinated alkyl (meth)acrylate included in the resin composition of an embodiment may be a perfluorine compound with one end modified with (meth)acrylic or a perfluorine compound with both ends modified with (meth)acrylic. In an embodiment, the perfluorinated alkyl (meth)acrylate may include 1 to 6 carbon atoms and 3 to 13 fluorine atoms.

Examples of the perfluorinated alkyl (meth)acrylate include 2,2,2-trifluoroethyl (meth)acrylate, 1,1,2,2,2-pentafluoroethyl (meth)acrylate, 3,3,3-trifluoroethyl (meth)acrylate, 2,2,2,3,3-pentafluoroethyl (meth)acrylate, etc., but are not limited thereto.

The silicone (meth)acrylate included in the resin composition of an embodiment may be a silicone compound with one or both ends modified with (meth)acrylic. The silicone (meth)acrylate of an embodiment may be a silicone compound with one end modified with (meth)acrylic. For example, the silicone (meth)acrylate may be represented by Formula 1 below.

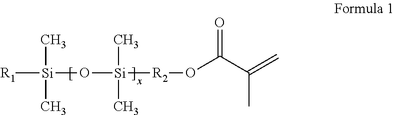

In Formula 1, R₁ is an alkyl group with 1 to 20 carbon atoms, R₂ is an alkylene group with 1 to 20 carbon atoms, and X is an integer of 1 to 20.

In the present description, unless otherwise specified, an alkyl group may be a linear, branched or cyclic type. The number of carbon atoms in the alkyl group is 1 to 20, 1 to 10, or 1 to 6. Examples of the alkyl group may include a methyl group, an ethyl group, an n-propyl group, an isopropyl group, an n-butyl group, a s-butyl group, a t-butyl group, an i-butyl group, a 2-ethylbutyl group, a 3,3-a dimethylbutyl group, an n-pentyl group, an i-pentyl group, a neopentyl group, a t-pentyl group, a cyclopentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, a cyclohexyl group, a 4-methylcyclohexyl group, a 4-t-butylcyclohexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, a cyclooctyl group, an n-nonyl group, an n-decyl group, an adamantyl group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldocecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, an n-nonadecyl group, etc., but are not limited thereto.

In the present description, the above description regarding the alkyl group may be applied to an alkylene group, except that the alkylene group may also be a divalent group.

Examples of the silicone (meth)acrylate with one end modified with (meth)acrylic may include Silaplane® FM-0711, Silaplane® FM-0721, Silaplane® FM-0725, Silaplane® TM-0701, Silaplane® TM-0701T, Shin-Etsu Silicone® X-22-174DX, ShinEtsu Silicone® X-22-2426, Shin-Etsu Silicone® X-22-2475, etc., but are not limited to thereto. Examples of the silicone (meth)acrylate with both ends modified with (meth)acrylic may include Shin-Etsu Silicone® X-22-162C], etc., but are not limited thereto. Additionally or alternatively, the silicone (meth)acrylate may include a hydroxyl group-containing silicone-modified (meth)acrylate, for example, BYK®-SILCLEAN® 3700, etc.

The C9 type hydrocarbon resin, according to an embodiment, may be used as a tackifier, and may be a resin material obtained by polymerizing an olefin with 9 carbon atoms or a cyclic olefin, or copolymerizing an aldehyde, an aromatic hydrocarbon, or a terpene compound. As shown in Image 1, the C9 aromatic hydrocarbon may be a copolymer of at least one monomer selected from among indene, methylindene, dicyclopentadiene, styrene, alphamethylstyrene, and various vinyl toluenes.

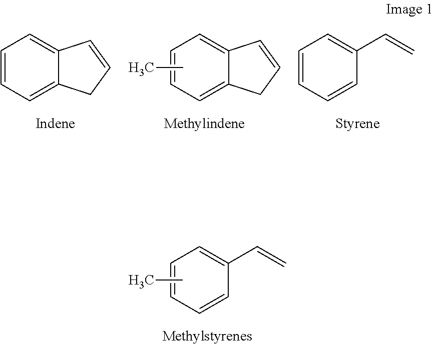

In an embodiment, the C9 type hydrocarbon resin may be a vinyl toluene/styrene copolymer. The vinyl toluene/styrene copolymer may have a weight-average molecular weight (Mw) of about 1000 to about 1500 and a softening point of about 75 to ° C. to about 120° C., thereby providing superior adhesive strength and reliability.

The C9 type hydrocarbon resin, according to an embodiment of the inventive concept, is non-polar and has good compatibility, thereby increasing adhesive strength and solving a transition phenomenon observed in the reliability test of the following examples.

In an embodiment, the C9 type hydrocarbon resin may be included in an amount of 4 to 10 parts by weight, or 6 to 10 parts by weight. When the C9 type hydrocarbon resin is greater than the above range, it is difficult to obtain the transparency of an adhesive layer. Additionally or alternatively, when the C9 type hydrocarbon resin is less than the above range, the adhesive strength may be reduced.

Examples of the curing agent according to an embodiment may include a diisocyanate-based compound, and for example, the diisocyanate-based compound may be 2,4-toluene diisocyanate, isophorone diisocyanate, 1,6-hexamethylene diisocyanate, 4,4′-dicyclohexylmethane diisocyanate, xylene diisocyanate, 1,5-naphthalene diisocyanate, lysine diisocyanate, trimethylhexamethylene diisocyanate, 2,2-bis-4′-propane isocyanate, 6-isopropyl-1,3-phenyldiisocyanate, 1,6-hexanediisocyanate, phenylenediisocyanate, 4,4′-biphenylenediisocyanate, 3,3′-dimethylphenylenediisocyanate, etc., but are not limited thereto.

Meanwhile, the adhesive layer AL may further contain an additive. Examples of the additive may include photosensitizers, polymerization inhibitors, polymerization initiators, leveling agents, surfactants, adhesion-imparting agents, plasticizers, ultraviolet ray absorbers, antioxidants, storage stabilizers, antistatic agents, inorganic fillers, pigments, dyes, etc., but are not limited to thereto.

The method of forming the adhesive layer AL is not particularly limited and may involve, for example, forming the adhesive layer AL from a two-liquid type adhesive composition including a first liquid and a second liquid. For example, the first liquid may include a resin composition and a C9 type hydrocarbon resin, and the second liquid may include a curing agent. When the adhesive composition is a two-liquid type adhesive composition, the adhesive composition may be prevented from being cured while being stored. The method of forming the adhesive layer AL will be described in more detail through the following examples.

Hereinafter, with reference to Examples and Comparative Examples, a resin composition, a protective sheet, and a display device of an embodiment of the inventive concept will be described. Additionally or alternatively, Examples shown below are illustrated for the understanding of the inventive concept, and the scope of the inventive concept is not limited thereto.

In an example embodiment of preparing protective sheets, preparation of the resin composition is may include equipping the inside of a flask with a nitrogen injector and cleaning a thermostat with nitrogen gas. Then 53 parts by weight of 2-ethylhexyl acrylate, 20 parts by weight of methyl acrylate, and 10 parts by weight of poly (ethylene glycol) methyl ether methacrylate, 10 parts by weight of 2,2,2-trifluoroethyl acrylate, 2 parts by weight of 2-hydroxyethyl acrylate, and 5 parts by weight of dimethylsiloxane alkyl methacrylate were introduced to the flask. 100 parts by weight of ethyl acetate as a solvent and 0.02 parts by weight of azobisisobutyronitrile (AIBN) as a polymerization initiator were added thereto, heated at 60° C. in a stream of nitrogen, reacted for 6 hours, and the reaction temperature was raised to 65° C., 0.02 parts by weight of azobisisobutyronitrile (AIBN) was added, and a reaction was further performed for 4 hours. The fluorine-silicone-alkyl type acrylic resin obtained after completion of the reaction had a solid content of 39% to 41% and a viscosity of 1500 cps to 2000 cps.

Preparation of an adhesive sheet my include mixing 8 parts by weight of a vinyltoluene/styrene copolymer (Piccotex™ LC) as a C9 type hydrocarbon resin and 0.15 parts by weight of a modified polyisocyanate (coronate HX) as a curing agent with 100 parts by weight of the resin obtained in Step A above to prepare an adhesive composition. A 100 μm PET was coated with the prepared adhesive composition and dried so as to have a dried film thickness of 15 μm and aged at 60° C. for 3 days to form a protective sheet.

In another example embodiment, 100 parts by weight of the resin, 4 parts by weight of a vinyl toluene/styrene copolymer as a C9 type hydrocarbon resin, and 0.15 parts by weight of a modified polyisocyanate as a curing agent were mixed to prepare an adhesive composition. Using the adhesive composition, a protective sheet may be formed

As a comparative example, a protective sheet was formed in the same manner as the above example, except that 12 parts by weight of a vinyltoluene/styrene copolymer was included as a C9 type hydrocarbon resin. In another comparative example, a protective sheet may be formed except that a C9 type hydrocarbon resin may not be included.

In another comparative example, 100 parts by weight of a commercially available acrylic adhesive SA467, instead of a C9 type hydrocarbon resin and 0.5 parts by weight of a curing agent, SC5EX, were mixed to prepare an adhesive composition. Using the adhesive composition, a protective sheet may be formed. In another comparative example, 100 parts by weight of a commercially available acrylic adhesive SA467, 8 parts by weight of a tackifier Piccotex™ LC, and 0.5 parts by weight of a curing agent SC5EX were mixed to prepare an adhesive composition. A protective sheet may be formed.

In another comparative example, 100 parts by weight of a commercial silicone adhesive such as Dow Corning 7358 and 0.5 part by weight of a curing agent, SC5EX, were mixed to prepare an adhesive composition. A protective sheet may be formed. Physical property tests have been performed by the following method, and the results thereof are shown in Table 1 below.

The protective sheets according to Examples and Comparative Examples were cut to a size of about 25 mm (width)×100 mm (length). The protective sheets were then attached onto SUS (JIS standard) and adhered by applying a 2 kg-load compaction roller once at a rate of 300 mm/min. After a certain time period, the force used to peel 180° of the protective sheet was measured at a rate of 300 mm/min with EZ-SX UTM and evaluated as SUS adhesive strength. The SUS adhesive strength is an index of the adhesive strength to stainless steel.

The protective sheets, according to Examples and Comparative Examples, were cut to a size of 25 mm (width)×100 mm (length). The protective sheets were then attached onto a fluorine-based AF film and adhered by applying a 2 kg-load compaction roller once at a rate of 300 mm/min. After a certain time period, the force used to peel 180° of the protective sheet was measured with a CKPT-999S at a rate of 2400 mm/min, and evaluated as fluorine-based AF film adhesive strength. The fluorine-based AF film adhesive strength is an index of the adhesive strength to a low surface energy support.

Reliability (85° C./80%*10 days) of the protective sheets according to Examples and Comparative Examples may be determined by attaching the protective sheets to a stainless steel SUS and a fluorine AF film (which are adherends) and left standing for 10 days at 85° C. and at a relative humidity of 80% in a thermo-hygrostat. Thereafter, the protective sheets according to Examples and Comparative Examples were peeled off, and then whether the adhesive layer was transitioned and the state of transition were observed with naked eyes.

TABLE 1

| | | | Comp. | Comp. | Comp. | Comp. | Comp. |
|---|---|---|---|---|---|---|---|
| Material: | Ex. 1 | Ex. 2 | Ex. 1 | Ex. 2 | Ex. 3 | Ex. 4 | Ex. 5 |
| Step A resin | 100 | 100 | 100 | 100 | — | — | — |
| composition of | | | | | | | |
| Example 1 | | | | | | | |
| Commercial | — | — | — | — | 100 | 100 | |
| acrylic adhesive | | | | | | | |
| (SA467) | | | | | | | |
| Commercial | — | — | — | — | — | | 100 |
| silicone adhesive | | | | | | | |
| (Dow Corning ® | | | | | | | |
| 7358) | | | | | | | |
| C9 type | 8 | 4 | 12 | — | — | 8 | — |
| hydrocarbon | | | | | | | |
| resin | | | | | | | |
| (piccotexTM LC) | | | | | | | |
| Curing | 0.15 | 0.15 | 0.15 | 0.15 | — | — | — |
| agent(coronate | | | | | | | |
| HX) | | | | | | | |
| Curing agent | — | — | — | — | 0.5 | 0.5 | — |
| (SC5EX) | | | | | | | |
| SUS adhesive | 600 | 430 | n.d. | 250 | 1500 | 2400 | 1450 |
| strength | | | | | | | |
| (gf/in) | | | | | | | |
| Fluorine- | 25.5 | 15 | n.d. | 6.5 | 4.2 | 5.1 | 5.5 |
| based AF | | | | | | | |
| film adhesive | | | | | | | |
| strength | | | | | | | |
| (gf/in) | | | | | | | |
| Reliability | OK | OK | n.d. | OK | | Surface | Surface |
| (85° C./ | | | | | | transition | transition |
| 80%*10 days) | | | | | | | |
| Adhesive film | Transparent | Transparent | non- | Transparent | Transparent | Transparent | Transparent |
| appearance | | | transparent | | | | |

Table 1 shows the protective sheets of Examples have superior adhesive strength and reliability and obtain transparency, compared to the protective sheets of Comparative Examples.

A resin composition of an embodiment includes fluorine and silicone materials and may have good adhesion to an adherend with low surface energy. A protective sheet of an embodiment includes an adhesive layer formed from a resin composition containing fluorine and silicone materials and may thus have increased wettability and adhesion. A display device of an embodiment includes a protective sheet with increased wettability and adhesion and may thus have increased reliability in an operating state such as folding.

Although the inventive concept has been described with reference to a preferred embodiment of the inventive concept, it will be understood that the inventive concept should not be limited to these preferred embodiments but various changes and modifications can be made by those skilled in the art without departing from the spirit and scope of the inventive concept.

Accordingly, the technical scope of the inventive concept is not intended to be limited to the contents set forth in the detailed description of the specification but is intended to be defined by the appended claims.

What is claimed is:

1. A protective sheet, comprising a base film and an adhesive layer formed of an adhesive composition,
wherein the adhesive composition includes:
a resin composition containing alkyl acrylate, polyethylene glycol alkyl ether methacrylate, hydroxyalkyl acrylate, perfluorinated alkyl (meth)acrylate, and silicone (meth)acrylate;
a C9 type hydrocarbon resin; and
a curing agent.

2. The protective sheet of claim 1, wherein the adhesive composition comprises 80 to 120 parts by weight of the resin composition, 4 to 10 parts by weight of the C9 type hydrocarbon resin, and 0.1 to 0.2 parts by weight of the curing agent.

3. The protective sheet of claim 1, wherein the curing agent is a diisocyanate-based compound.

4. The protective sheet of claim 1, wherein the C9 type hydrocarbon resin is a copolymer of at least one monomer selected from among indene, styrene, methylindene, alphamethylstyrene, and vinyltoluene.

5. The protective sheet of claim 1, wherein the adhesive layer has a thickness of 5 μm to 40 μm.

6. The protective sheet of claim 1, wherein the perfluorinated alkyl (meth)acrylate comprises an alkyl group of 1 to 6 carbon atoms and 3 to 13 fluorine atoms.

7. The protective sheet of claim 1, wherein the resin composition comprises:
58 to 88 parts by weight of the alkyl acrylate;
8 to 12 parts by weight of the polyethylene glycol alkyl ether methacrylate;
1.5 to 2.5 parts by weight of the hydroxyalkyl acrylate;
8 to 12 parts by weight of perfluorinated alkyl (meth)acrylate; and
4 to 6 parts by weight of the silicone (meth)acrylate.

8. A display device, comprising:
a display module; and
a protective sheet disposed on the display module,
wherein the protective sheet includes
an adhesive layer formed of an adhesive composition containing a resin composition with alkyl acrylate, polyethyleneglycol alkylether methacrylate, hydroxyalkyl acrylate, perfluorinated alkyl (meth)acrylate, and silicone (meth)acrylate, a C9 type hydrocarbon resin, and a curing agent, and
a base film disposed on the adhesive layer.

9. The display device of claim 8, wherein the display module comprises a display panel and a window disposed on the display panel, and
the window includes:
a base substrate; and
at least one functional layer disposed on the base substrate and including a fluorine-containing compound.

10. The display device of claim 9, wherein the adhesive layer is directly disposed on the at least one functional layer including the fluorine-containing compound, and wherein a bond is not formed between the adhesive layer and the functional layer.

11. The display device of claim 9, wherein an adhesive strength of the protective sheet to the functional layer containing the fluorine-containing compound is 10 gf/inch to 100 gf/inch.

12. The display device of claim 8, wherein the adhesive layer has a thickness of 5 μm to 40 μm.

13. The display device of claim 8, wherein the display module is foldable with respect to at least one bending axis.
